(19) United States
(12) Patent Application Publication
(10) Pub. No.: US 2017/0113076 A1
(43) Pub. Date: Apr. 27, 2017

(54) CLOTHING WITH BUILT-IN RESPIRATORY FILTER

(71) Applicant: BioLx, Inc., New York, NY (US)

(72) Inventors: Yosef P. Krespi, New York, NY (US); Ron Hadani, Teaneck, NJ (US); Selomo Ozinci, Tel-Aviv (IL)

(21) Appl. No.: 15/335,052

(22) Filed: Oct. 26, 2016

Related U.S. Application Data
(60) Provisional application No. 62/246,764, filed on Oct. 27, 2015.

(51) Int. Cl. A62B 23/02; A41B 1/08; A62B 17/04; A62B 18/02; A62B 18/08; A41D 13/11; A41D 13/04

(52) U.S. Cl. CPC A62B 23/02; A41D 13/1153; A41D 13/1161; A41B 1/08; A41D 13/04; A62B 18/025; A62B 18/084; A62B 17/04; A41D 2200/20

(57) ABSTRACT

An article of clothing with a built-in respiratory filter is disclosed herein. In an embodiment, the article of clothing includes a collar configured to be worn around a wearer's neck, a respiratory filter positioned below the collar, and an attachment mechanism configured to secure the collar above the wearer's nose when desired by the wearer, wherein the respiratory filter is positioned over the wearer's nose and/or mouth when the attachment mechanism secures the collar above the wearer's nose.

### FIELD OF THE DISCLOSURE

The present disclosure relates generally to an article of clothing with a built-in respiratory filter, and more specifically to an article of clothing that can be lifted over a wearer's nose and mouth to filter air breathed by the wearer.

### BACKGROUND

Respiratory face masks are worn for a variety of professions. Industrial workers wear face masks to filter dust, small particles, pollutants, chemical agents and dangerous gases from the air. Medical workers wear face masks as protection against microorganisms, splashes or sprays of blood, body fluids, secretions and excretions to protect against the contraction of infectious diseases.

### SUMMARY

The present disclosure is directed to an article of clothing with a built-in respiratory filter. In a general example embodiment, an article of clothing includes a collar configured to be worn around a wearer's neck, a respiratory filter positioned below the collar, and an attachment mechanism configured to secure the collar above the wearer's nose when desired by the wearer, wherein the respiratory filter is positioned over the wearer's nose and/or mouth when the attachment mechanism secures the collar above the wearer's nose.

In another example embodiment, a wearable air filter includes an article of clothing including a collar configured to be worn around a wearer's neck, an attachment mechanism configured to secure the collar in a filtering configuration above the wearer's nose, and a respiratory filter attached to the article of clothing below the collar and configured to be positioned over the wearer's nose and/or mouth to filter air breathed by the wearer when the attachment mechanism secures the collar in the filtering configuration.

In another example embodiment, a method of manufacturing a wearable air filter includes attaching a respiratory filter to an article of clothing below a collar of the article of clothing, and attaching an attachment mechanism to the article of clothing so that the attachment mechanism can secure the respiratory filter over a nose and/or mouth of a wearer of the article of clothing.

In another example embodiment, an article of clothing includes means for filtering air breathed through the nose and/or mouth of a wearer of the article of clothing, and means for securing the means for filtering air over the wearer's nose and/or mouth.

In another example embodiment, a bib for attachment to an article of clothing includes a first attachment mechanism to attach the bib to the article of clothing, a second attachment mechanism to secure a collar of the article of clothing in a filtering configuration above the wearer's nose and/or mouth after the first attachment mechanism has attached the bib to the article of clothing, and a respiratory filter configured to be positioned over the wearer's nose and/or mouth to filter air breathed by the wearer when the second attachment mechanism secures the collar in the filtering configuration.

In another example embodiment, a wearable air filter includes an article of clothing including a collar configured to be worn around a wearer's neck, a flap attached to the article of clothing at or near the collar, the flap configured to be flipped upwards into a filtering configuration over the wearer's nose and/or mouth, a respiratory filter attached to the flap so as to be positioned over the wearer's nose and/or mouth to filter air breathed by the wearer when the flap is flipped upwards into the filtering configuration over the wearer's nose and/or mouth, and an attachment mechanism configured to secure the flap in the filtering configuration over the wearer's nose and/or mouth.

In another example embodiment, a shirt includes a collar configured to be worn around a wearer's neck, and an attachment mechanism configured to secure the collar above the wearer's nose when desired by the wearer, wherein the attachment member is at least one of: (i) a nose attachment mechanism; (ii) an ear attachment mechanism; and (iii) a chin attachment mechanism.

In another example embodiment, an article of clothing includes a hood configured to cover a wearer's head when flipped upwards into a filtering configuration, a respiratory filter attached to the hood and configured so as to be positioned over the wearer's nose and/or mouth to filter air breathed by the wearer when the hood is flipped upwards into the filtering configuration, and a viewing mechanism configured to allow the wearer to look through the hood when the hood is flipped upwards into the filtering configuration.

### BRIEF DESCRIPTION OF THE FIGURES

Embodiments of the present disclosure will now be explained in further detail by way of example only with reference to the accompanying figures, in which:

FIG. 1 shows a front elevational view of an article of clothing according to the present disclosure;

FIG. 2 shows a back elevational view of the article of clothing of FIG. 1;

FIG. 3 shows a front perspective view of the article of clothing of FIG. 1 being used by a wearer to provide a filter for the wearer's nose and mouth;

FIG. 4 shows a front elevational view of an article of clothing according to the present disclosure;

FIG. 5 shows a back elevational view of the article of clothing of FIG. 4;

FIG. 6 shows a front elevational view of an article of clothing according to the present disclosure;

FIG. 7 shows a back elevational view of the article of clothing of FIG. 6;

FIG. 8 shows a front elevational view of the article of clothing of FIG. 6 with a flap in a raised configuration;

FIG. 9 shows a back elevational view of the article of clothing of FIG. 6 with the flap in a raised configuration;

FIG. 10 shows a bib that can be attached to an article of clothing and used as an air filter according to the present disclosure;

FIG. 11 shows a front elevational view of an article of clothing according to the present disclosure; and

FIG. 12 shows a back elevational view of the article of clothing of FIG. 11;

FIG. 13 shows a front elevational view of an article of clothing according to the present disclosure;

FIG. 14 shows a back elevational view of the article of clothing of FIG. 13;

FIG. 15 shows a front elevational view of the article of clothing of FIG. 13 with a collar in a raised configuration;

FIG. 16 shows a back elevational view of the article of clothing of FIG. 13 with the collar in a raised configuration;

FIG. 17 shows a front elevational view of an article of clothing according to the present disclosure;

FIG. 18 shows a back elevational view of the article of clothing of FIG. 17;

FIG. 19 shows a front perspective view of the article of clothing of FIG. 17 being used by a wearer to provide a filter for the wearer's nose and mouth;

FIG. 20 shows a front elevational view of an article of clothing according to the present disclosure;

FIG. 21 shows a back elevational view of the article of clothing of FIG. 20; and

FIG. 22 shows a front perspective view of the article of clothing of FIG. 20 being used by a wearer to provide a filter for the wearer's nose and mouth.

### DETAILED DESCRIPTION

Before the disclosure is described, it is to be understood that this disclosure is not limited to the particular apparatuses and methods described. It is also to be understood that the terminology used herein is for the purpose of describing particular embodiments only, and is not intended to be limiting, since the scope of the present disclosure will be limited only to the appended claims.

As used in this disclosure and the appended claims, the singular forms “a,” “an” and “the” include plural referents unless the context clearly dictates otherwise. The methods and apparatuses disclosed herein may lack any element that is not specifically disclosed herein. Thus, “comprising,” as used herein, includes “consisting essentially of” and “consisting of.”

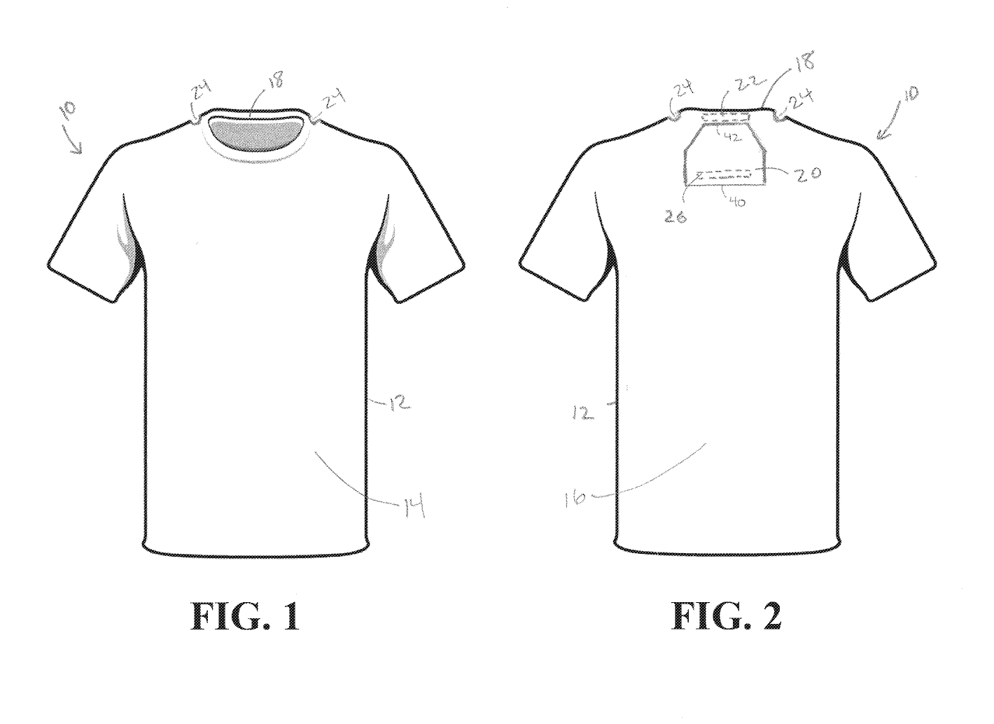

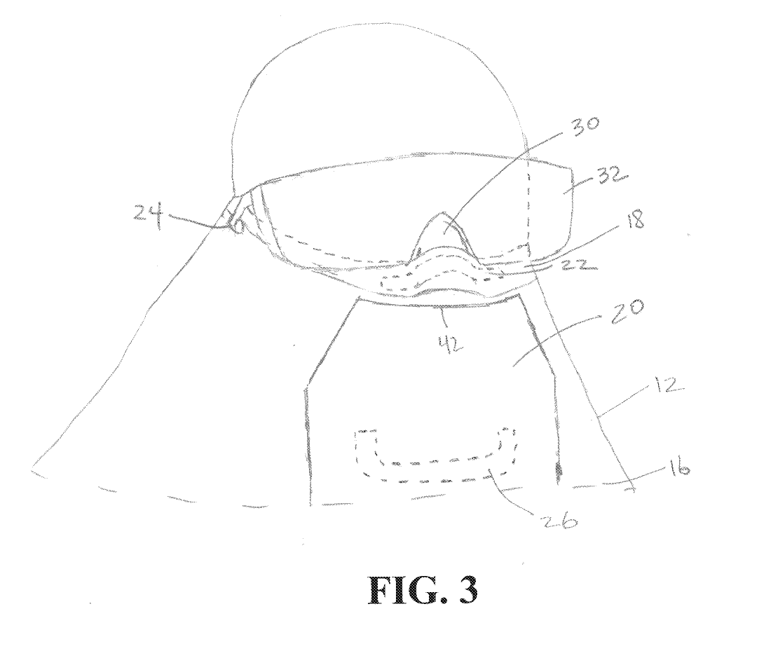

FIGS. 1 to 3 illustrate an embodiment of an article of clothing 10 according to the present disclosure. The article of clothing 10 is preferably a shirt 12, as illustrated in FIGS. 1 and 2, but those of ordinary skill in the art will recognize that the present disclosure can be applied to other types of clothing. In use, the article of clothing 10 can be pulled upward to cover a wearer's nose and mouth and provide the wearer with a convenient respiratory filter 20, as illustrated in FIG. 3.

Shirt 12 includes a respiratory filter 20, a nose attachment mechanism 22, one or more ear attachment mechanisms 24 and a chin attachment mechanism 26. In the illustrated embodiment, respiratory filter 20 is placed on the rear side 16 of shirt 12 because the rear side 16 of the shirt 12 typically has a higher collar line that can be used to cover the wearers face. Since respiratory filter 20 is placed on the rear side 16 of shirt 12, the wearer must reverse shirt 12 to use the respiratory filter 20. Those of ordinary skill in the art will understand that the respiratory filter 20 can also be placed on the front side 14 of the shirt 12 to make the respiratory filter 20 easier to access by the wearer.

FIG. 3 illustrates shirt 12 in a filtering configuration, after the wearer has reversed shirt 12 so that the rear side 16 is facing forward, and after the wearer has pulled the collar 18 of shirt 12 above the wearer's nose 30 and mouth. As illustrated, when the collar 18 of shirt 12 is pulled above the wearer's nose 30 and mouth, respiratory filter 20 is located to cover the wearer's nose 30 and mouth so that air breathed in by the wearer must pass through respiratory filter 20. In the both the filtering configuration shown in FIG. 3 and the non-filtering configuration shown in FIGS. 1 and 2, the collar 18 of shirt 12 is located above the respiratory filter 20.

Nose attachment mechanism 22, ear attachment mechanisms 24 and chin attachment mechanism 26 allow respiratory filter 20 to be secured over the wearer's nose and mouth in the filtering configuration shown in FIG. 3. Nose attachment mechanism 22 is located to contact the wearer's nose when collar 18 is pulled up over the wearer's nose, ear attachment mechanisms 24 are located to be near the wearer's ears when collar 18 is pulled up over the wearer's nose, and chin attachment mechanism 26 is located to contact the wearer's chin when collar 18 is pulled up over the wearer's nose. It will be understood by those of ordinary skill in the art that shirt 12 can be secured to the wearer's face with only one of nose attachment mechanism 22, ear attachment mechanism 24 and chin attachment 26, but that using each of nose attachment mechanism 22, ear attachment mechanism 24 and chin attachment 26 will more securely fasten shirt 12 over the wearer's face when desired by the wearer. It will also be understood by those of ordinary skill in the art that shirt 12 can be secured in the filtering configuration using an attachment mechanism that does not involve the wearer's nose, ears or chin.

In the illustrated embodiment, nose attachment mechanism 22 is a bendable nose strip, for example a metal strip or wire, that is located at or near the collar 18 of shirt 12 to contact the wearer's nose 30 when collar 18 is pulled up over the wearer's nose 30. In a preferred embodiment, the bendable nose strip is a metal wire that is about 127 to 152.4 millimeters (5 to 6 inches) long and about 3 millimeters (0.12 inches) wide. When the bendable nose strip is positioned over the wearer's nose 30, the wearer can apply pressure against the bendable nose strip to squeeze the bendable nose strip against the wearer's nose 30 so that the bendable nose strip pinches the wearer's nose 30 and secures the collar 18 against the wearer's nose. Although the illustrated embodiment shows a bendable nose strip, those of ordinary skill in the art will recognize that other nose attachment mechanisms 22 can be used, for example, a nose pad that is automatically biased to pinch the wearer's nose 30, or a nose pad that is not attached to the shirt 12 at collar 18 but is placed over the shirt 12 to pinch the wearer's nose 30 after shirt 12 is pulled up over the wearer's nose 30. Further, although the illustrated embodiment shows nose attachment mechanism 22 located above respiratory filter 20, nose attachment mechanism 22 can also overlap respiratory filter 20 or be placed in another location to secure respiratory filter 20 over the wearer's nose and mouth.

In the illustrated embodiment, the ear attachment mechanisms 24 are apertures that are located on the right and left sides of shirt 12 at or near collar 18. In FIG. 3, the wearer's safety glasses are placed through the apertures to secure the right and left sides of shirt 12 against the right and left sides of the wearer's head. Alternatively, the apertures can be looped over the wearer's ears if the wearer does not need safety glasses. Although the illustrated embodiment shows the ear attachment mechanisms as apertures in shirt 12, those of ordinary skill in the art will recognize that other ear attachment mechanisms 24 can be used, for example, strings that are tied to shirt 12 that can be placed over the wearer's ears and/or glasses.

In the illustrated embodiment, chin attachment mechanism 26 is a bendable chin strip, for example a metal strip or wire, that overlaps or is located underneath respiratory filter 20 to contact the wearer's chin when collar 18 is pulled up over the wearer's nose 30. In a preferred embodiment, the bendable chin strip is a metal wire that is about 152.4 to 177.8 millimeters (6 to 7 inches) long and about 3 millimeters (0.12 inches) wide. When the bendable chin strip is positioned adjacent to the wearer's chin, the wearer can apply pressure against the bendable chin strip to squeeze the bendable chin strip against the wearer's chin so that the bendable chin strip pinches the wearer's chin and secures the respiratory filter against the wearer's chin. Although the illustrated embodiment shows a bendable chin strip, those of ordinary skill in the art will recognize that other chin attachment mechanisms 26 can be used, for example, a chin pad that is automatically biased to pinch the wearer's chin, or a chin pad that is not attached to the shirt 12 but is placed over the shirt 12 to pinch the wearer's chin after collar 18 is pulled up over the wearer's nose 30. Further, although the illustrated embodiment shows chin attachment mechanism 26 overlapping respiratory filter 20, chin attachment mechanism 26 can be located below respiratory filter 20 or be placed in another location to secure respiratory filter 20 over the wearer's nose and mouth.

It will be understood by those of ordinary skill in the art that the nose attachment mechanism 22, ear attachment mechanism 24 and/or chin attachment mechanism 26 can be replaced with or supplemented with one or more other attachment mechanisms. For example, in one embodiment, a string can be threaded through the collar 18 so that the string can be tightened around the wearer's face when the shirt 12 is pulled over the wearer's nose and mouth. In another embodiment, the string can tighten only a portion of the collar 18 to tighten the collar 18 of shirt 12.

In addition to securing respiratory filter over the wearer's nose and mouth, attachment mechanism 22, ear attachment mechanism 24 and chin attachment mechanism 26 are advantageous because they help seal respiratory filter 20 around the wearer's nose and mouth so that no air can be breathed by the wearer unless the air passes through respiratory filter 20. Additional sealing mechanisms can also be included, for example, metal wires or other bendable strips that are capable of matching the contour of the wearer's face along the entire perimeter of respiratory filter 20.

Respiratory filter 20 is an air-permeable, mesh or grid-like, porous structure that can be breathed through by the wearer, and is configured to filter dust, small particles, pollutants, chemical agents, dangerous gases and/or microorganisms from the air breathed by the wearer. In a preferred embodiment, respiratory filter 20 includes a copper mesh material that is attached to the article of clothing 10. Those of ordinary skill in the art will recognize other materials that can be used. Respiratory filter 20 can be located on the inside or outside of the article of clothing 10, or on the front 14 or rear 16 side as explained above. In a preferred embodiment, respiratory filter 20 is located on the outside of the article of clothing 10 so that it does not rub against the wearer's face when in the filtering configuration, with the wearer's face instead contacting the cotton or other soft material of the article of clothing 10 to provide a more comfortable fit.

In the illustrated embodiment of FIGS. 2 and 3, the shape of respiratory filter 20 is symmetrical hexagon, with the base or lower edge 40 of respiratory filter 20 being wider than the top or upper end 42. Respiratory filter 20 is shaped in this way so that the larger base portion of respiratory filer 20 that forms a rectangle can be placed over the wearer's mouth, while the smaller top portion that forms a trapezoid can be placed over the wearer's nose. Those of ordinary skill in the art will recognize, however, that any suitable shape can be used, as long as the shape permits the wearer to breathe through his or her nose and/or mouth. In an embodiment, the lower portion of respiratory filter 20 is larger than the top portion because the wearer's mouth is larger than the wearer's nose.

Shirt 12 is preferably formed of an elastic or stretchable material so that it can be stretched over the wearer's nose and mouth without causing discomfort for the wearer. In an embodiment, shirt 12 includes one or more of cotton, acrylic, polyester, rayon, spandex and/or other like materials. In an embodiment, shirt 12 includes about 25% to 50% acrylic, about 25% to 50% polyester, about 10% to 40% rayon and/or about 1% to 15% spandex, or more preferably about 37% acrylic, about 34% polyester, about 25% rayon and about 4% spandex. Those of ordinary skill in the art will recognize other suitable materials for shirt 12.

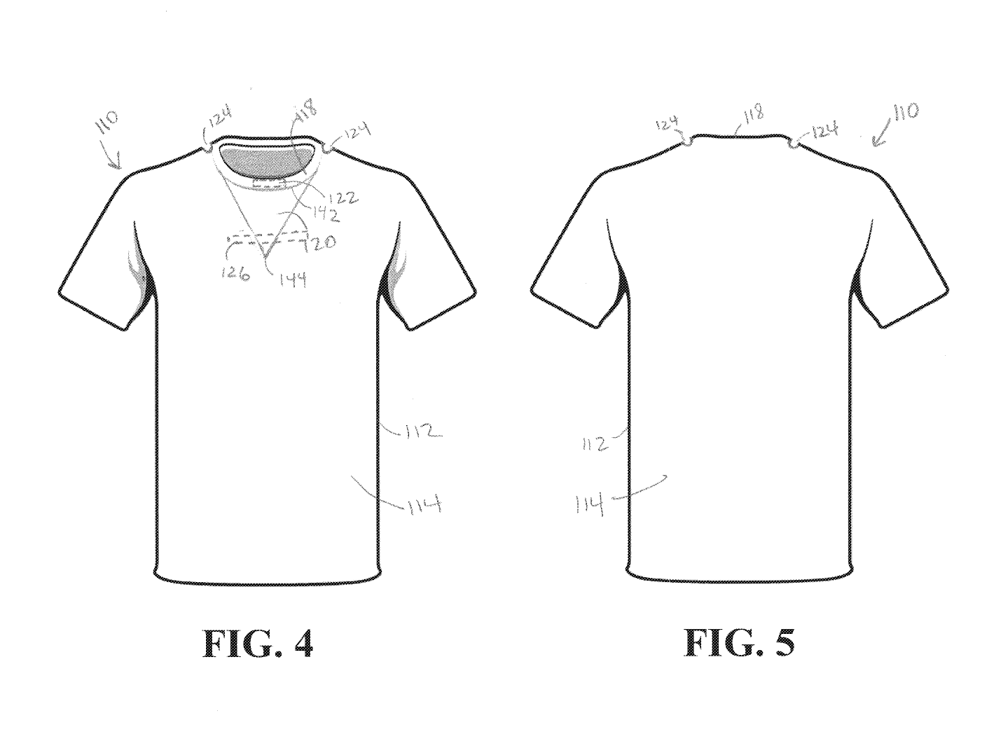

FIGS. 4 and 5 illustrate an alternative embodiment of an article of clothing 110 according to the present disclosure. In the illustrated embodiment, the article of clothing 110 is a shirt 112 including a respiratory filter 120, a nose attachment mechanism 122, one or more ear attachment mechanisms 124, and a chin attachment mechanism 126. One difference between article of clothing 110 and article of clothing 10 is that the respiratory filter 120 and nose attachment mechanism 122 have been attached to the front side 114 of shirt 112 as opposed to the rear side 116. Because respiratory filter 120 has been located on the front side 114 of the shirt 112, the wearer does not need to turn the shirt around to use the respiratory filter. As with shirt 12, the collar 118 of shirt 112 can be pulled above the wearer's nose, so that nose attachment mechanism 122 can pinch the wearer's nose, ear attachment mechanisms 124 can be placed around the wearer's ears and/or glasses, and chin attachment mechanism 126 can pinch the wearer's chin, to secure respiratory filter 120 in a filtering configuration.

In the illustrated embodiment, respiratory filter 120 has been formed as a triangle to appear more fashionable since it has been located on the front side 114 of shirt 112 and is more prominently displayed by the wearer than if located on rear side 116. In the illustrated embodiment, the upper edge 142 of the triangle is located at or near the collar 118, above the lower tip 144 of the triangle, similar to a popular shirt design. Those of ordinary skill in the art will recognize that other shapes and sizes can be used for the respiratory filter in addition to the triangle shown in FIG. 4 and the symmetrical hexagon shown in FIG. 1, for example, circles, squares, rectangles and trapezoids. The present disclosure allows the manufacturer or wearer to customize the shape and size of the respiratory filter for fashionability as well as functionality. In some cases, the wearer may opt for a more stylish design in which the respiratory filter blends into the design of the shirt. In other cases, the wearer may opt for a more functional design in which the respiratory filter is formed to optimize the area covered over the patient's nose and mouth. The present disclosure allows for fashionability, functionality, or a combination of both. For example, in an embodiment, the triangle shown in FIG. 4 can be flipped upside-down for a more functional design.

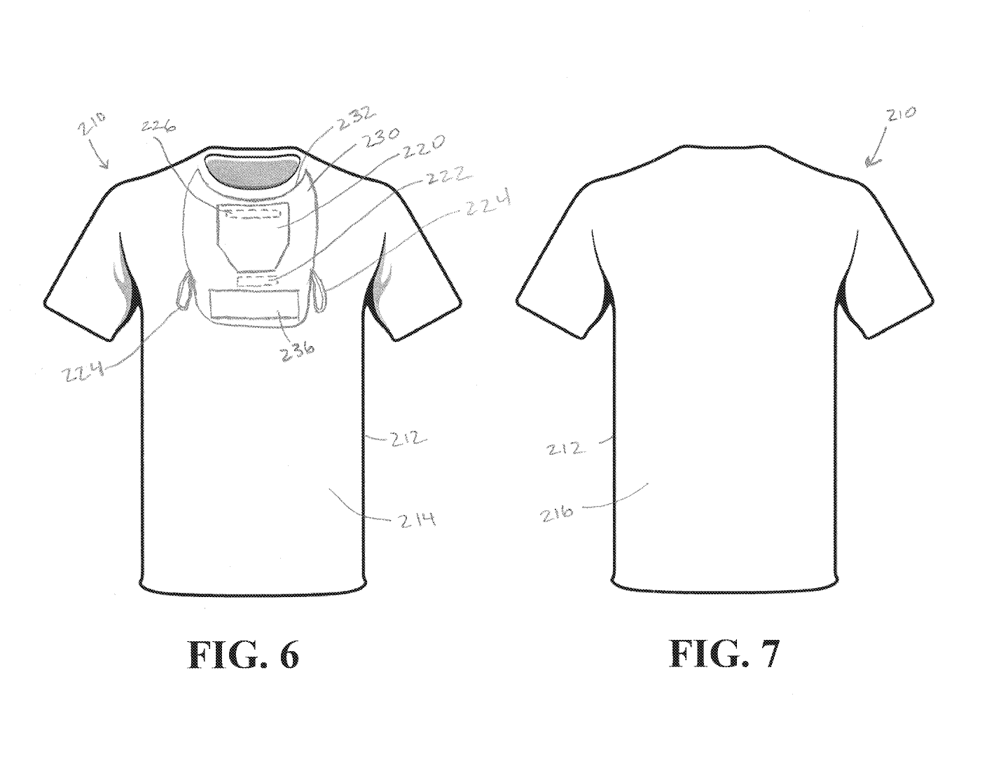

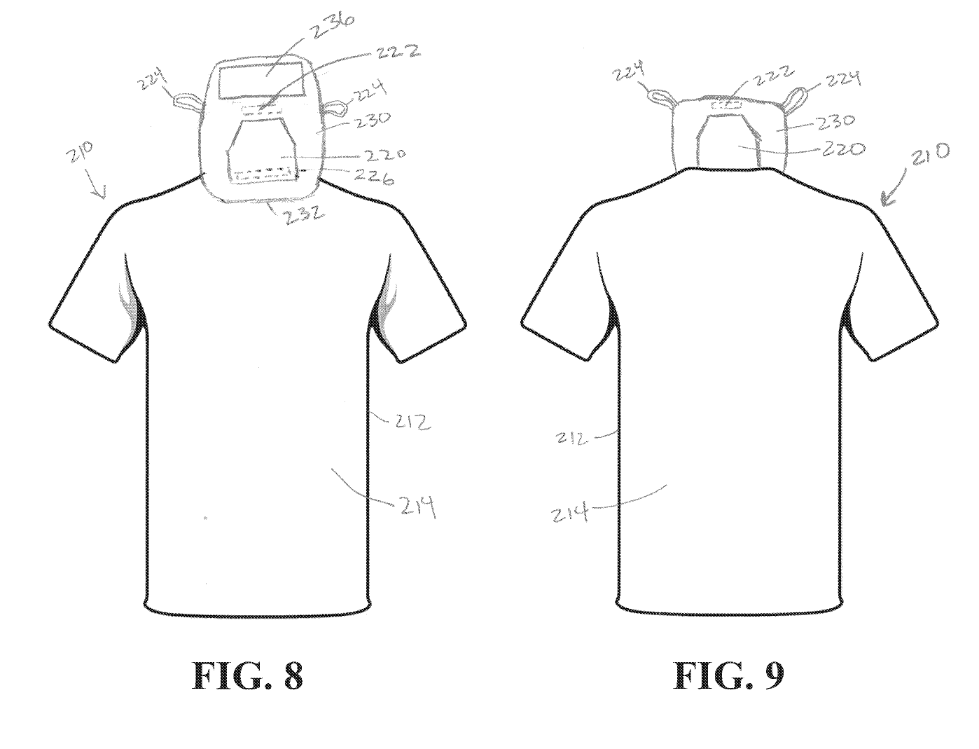

FIGS. 6 and 7 illustrate an alternative embodiment of an article of clothing 210 according to the present disclosure. In the illustrated embodiment, the article of clothing 210 is a shirt 212 including a respiratory filter 220, a nose attachment mechanism 222, one or more ear attachment mechanisms 224 and a chin attachment mechanism 226. The respiratory filter 220, nose attachment mechanism 222, one or more ear attachment mechanisms 224 and chin attachment mechanism are attached to a flap 230 that is secured to shirt 210 at an upper edge 232 of the flap 230. In use, the flap 230 can be folded upwards at upper edge 232 to cover the wearer's face, as illustrated for example at FIGS. 8 and 9. When the flap 230 has been folded upwards to cover the wearer's face, nose attachment mechanism 222 can be bent to pinch the wearer's nose, ear attachment mechanisms 224 can be looped over the wearer's ears, and chin attachment mechanism 226 can be bent to pinch the wearer's chin. As illustrated, respiratory filter 220 is upside-down in FIG. 6 because its position is reversed when flap 230 has been folded upwards as shown in FIG. 8. Unlike previous embodiments, respiratory filter 220 is located above the collar of the shirt when the respiratory filter 220 is in the filtering configuration. Flap 230 can be located on the front side 214 or back side 216 of shirt 212, or on the inside or outside of shirt 212. As illustrated, the flap 230 can also include an eye guard, for example a translucent plastic, capable of shielding the wearer's eyes when flap 230 has been folded upwards as shown in FIG. 8.

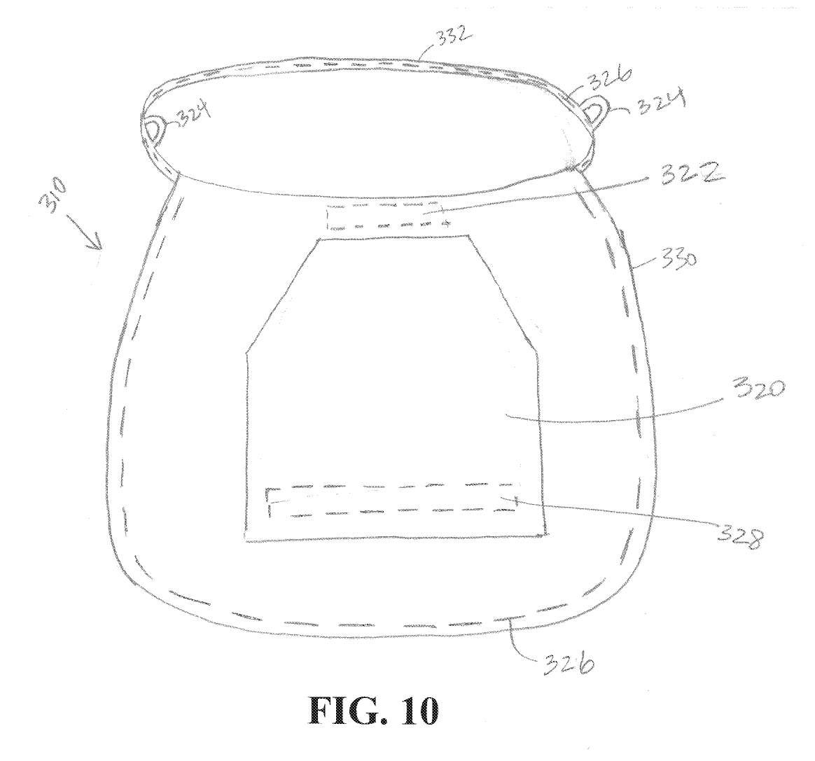

FIG. 10 illustrates an embodiment of a bib 310 that can be attached to a shirt or other wearable article of clothing so that the shirt or other wearable article of clothing can be used similar to the shirt 12 illustrated in FIGS. 1 to 3. As illustrated, bib 310 includes a respiratory filter 320, a nose attachment mechanism 322, one or more ear attachment mechanisms 324 and a chin attachment mechanism 328 that can be used similar to the respiratory filter 20, nose attachment mechanism 22, ear attachment mechanisms 24 and chin attachment mechanism 26 illustrated in FIG. 1 to 3. In use, bib 330 can be attached to a shirt or other wearable article of clothing using a wire 326 or another attachment mechanism, and then the shirt or other wearable article of clothing can be used just as the shirt 12 illustrated in FIGS. 1 to 3 by pulling the collar of the shirt or other wearable article of clothing above the wearer's nose so that the respiratory filter 320 is located over the wearers nose and mouth. In a preferred embodiment, bib 310 includes both a base 330 and a collar strap 332, but it will be understood by one of ordinary skill in the art that the collar strap 332 can be eliminated, and the base 332 can be sown onto a shirt or temporarily or permanently attached to a shirt with the wire 326 or other attachment mechanism. The advantage of including collar strap 332 with bib 310 is that collar strap 332 provides ear attachment mechanisms 324 that can be looped over the wearer's ears and/or glasses. Alternatively, bib 310 can be formed without collar strap 332, but with a wide enough width in base 330 that ear attachment mechanisms 334 can be located on base 330 and be positioned to be near the wearer's ears when an article of clothing including bib 330 is pulled over the wearer's nose.

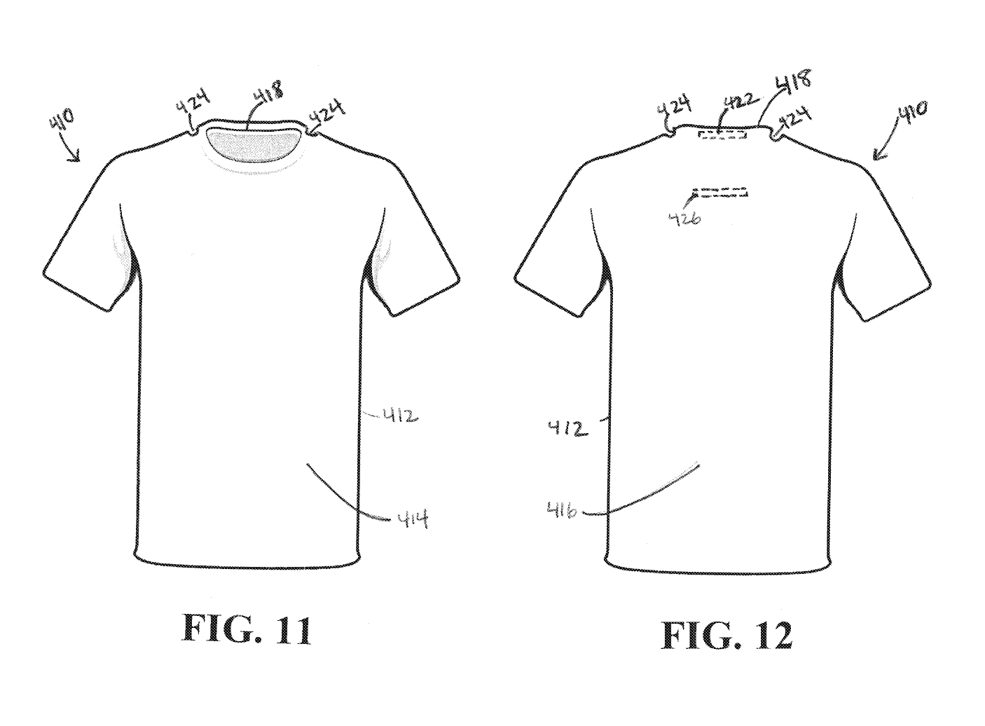

FIGS. 11 and 12 illustrate an alternative embodiment of an article of clothing 410 according to the present disclosure. In the illustrated embodiment, the article of clothing 410 is a shirt 412 including a nose attachment mechanism 422, one or more ear attachment mechanisms 424, and a chin attachment mechanism 426. The difference between article of clothing 410 and article of clothing 10 is that the respiratory filter 20 of article of clothing 10 has been removed. As with article of clothing 10, the collar 418 of shirt 412 can be pulled above the wearer's nose, so that nose attachment mechanism 422 can pinch the wearer's nose, ear attachment mechanisms 424 can be placed around the wearer's ears and/or glasses, and chin attachment mechanism 426 can pinch the wearer's chin, to secure collar 418 above the wearer's nose and shirt 412 over the wearer's nose and mouth. Shirt 412 will not filter air breathed by the wearer as well shirt 12 due to the absence of a copper mesh or other filtering material, but shirt 412 can still provide some level of filtering for the wearer. In the illustrated embodiment, nose attachment mechanism 422 and chin attachment mechanism 426 are attached to the rear side 416 of shirt 412 because the rear side 416 has a higher collar, but those of ordinary skill in the art will understand that nose attachment mechanism 422 and chin attachment mechanism 426 can also be placed on the front side 414 of the shirt 412 for easier access by the wearer.

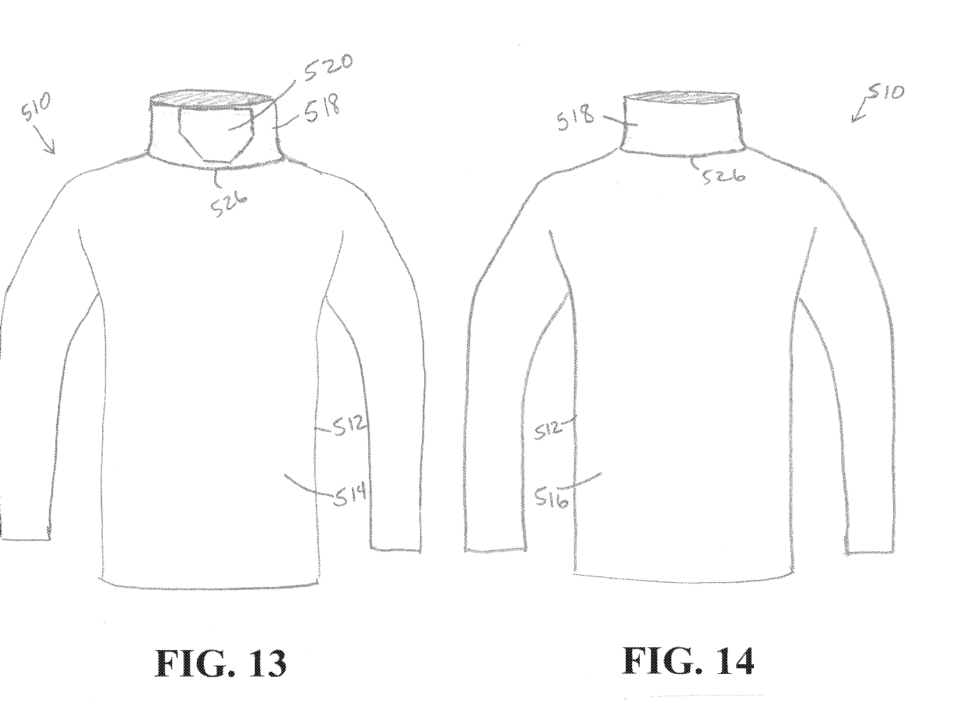

FIGS. 13 and 14 illustrate an alternative embodiment of an article of clothing 510 according to the present disclosure. In the illustrated embodiment, the article of clothing 510 is a shirt 512 with an extended collar 518 that is folded over itself for normal wear, for example, a turtleneck shirt. The extended collar 518 includes a respiratory filter 520 that is shown in a non-filtering configuration in FIGS. 13 and 14 in which respiratory filter 520 is shown upside-down because the top edge 526 of extended collar 518 has been folded down over the lower portion 528 of the extended collar 18.

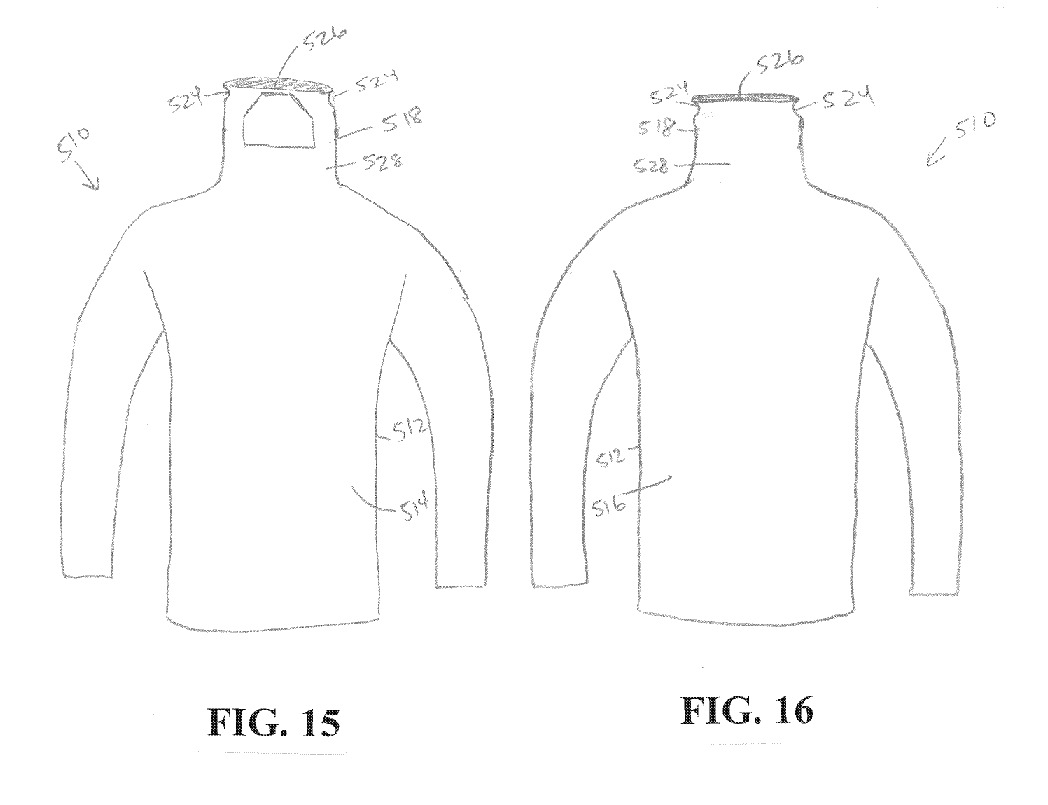

FIGS. 15 and 16 show respiratory filter 520 in a filtering configuration in which the extended collar has been unfolded so that the top edge 526 of extended collar 518 can be placed above a wearer's nose, so that the lower portion 526 of extended collar 518 is exposed, and so that respiratory filter 520 is located to cover the wearer's nose and/or mouth to filter the air breathed by the wearer. Extended collar 518 can further include an attachment mechanism to secure respiratory filter 520 over the wearer's nose and/or mouth. In the illustrated embodiment, extended collar 518 includes an ear attachment mechanism 524 comprising apertures located to hook the wearer's ears and/or glasses to hold extended collar 518 in the filtering configuration shown in FIGS. 15 and 16. Those of ordinary skill in the art will recognize that other attachment mechanisms and/or sealing mechanisms can be included on collar 518, for example, the nose attachment mechanism, chin attachment mechanism and other attachment mechanisms and/or sealing mechanisms described above. Those of ordinary skill in the art will also recognize that the elasticity of the extended collar 518 can act as the attachment mechanism by conforming around the wearer's face. Those of ordinary skill in the art will further recognize that respiratory filter 520 can be located on the front side 514 or rear side 516 of collar 518, and that the wearer of shirt 512 will have to reverse shirt 512 if respiratory filter 520 is located on rear side 516.

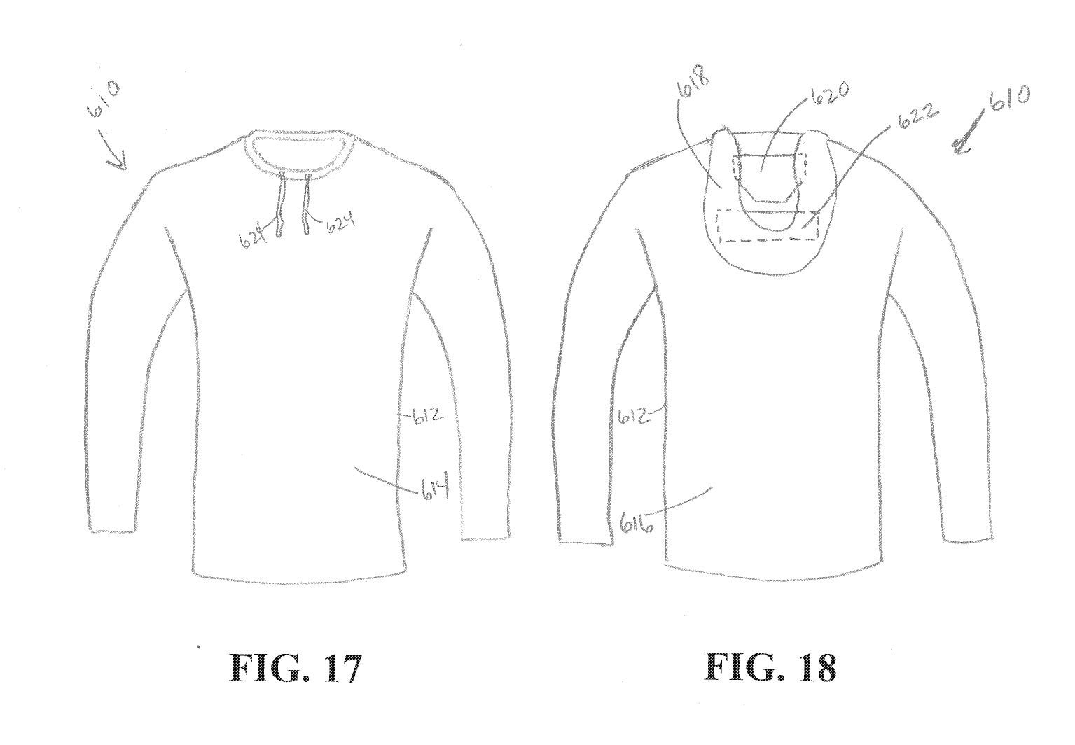

FIGS. 17 and 18 illustrate an alternative embodiment of an article of clothing 610 according to the present disclosure. In the illustrated embodiment, the article of clothing 610 is a shirt 612 with a hood 618. Hood 618 includes a respiratory filter 620 and a viewing mechanism 622. In the non-filtering configuration shown in FIGS. 17 and 18, the front side 614 of shirt 612 is facing forward, and respiratory filter 620 is shown upside-down because its position is reversed when respiratory filter 620 is placed in the filtering configuration.

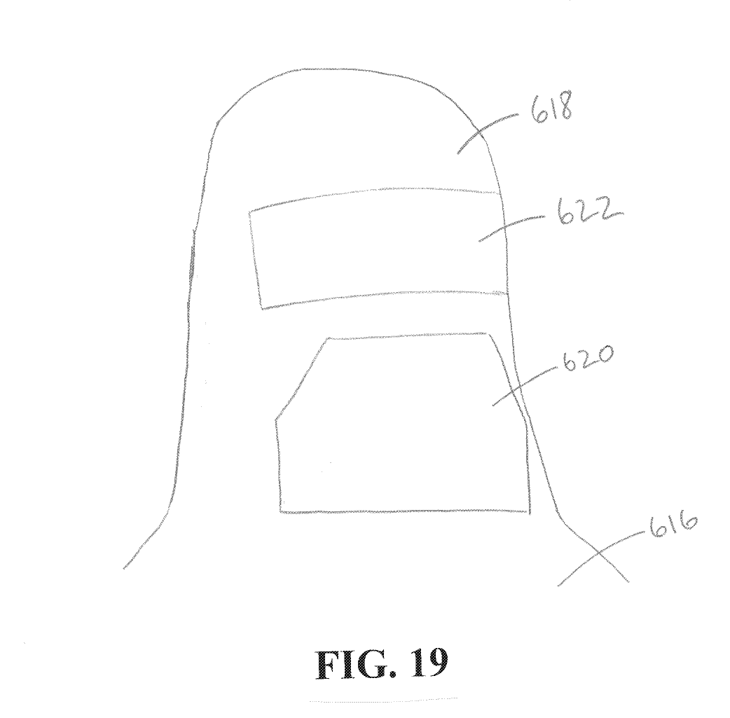

FIG. 19 shows respiratory filter 620 in the filtering configuration after shirt 612 has been reversed so that rear side 616 is facing forward, and after hood 618 has been pulled up over the wearer's head. In the filtering configuration, respiratory filter 620 is located to cover the wearer's nose and/or mouth to filter air breathed by the wearer, and viewing mechanism 622, for example an eye guard including translucent plastic, is located to cover the wearer's eyes so that the wearer can look through viewing mechanism 622. In the filtering configuration, the wearer can tighten strings 624 to secure hood 618 around the wearer's head. In an embodiment, hood 618 can also include one or more of the nose attachment mechanism, ear attachment mechanism, chin attachment mechanism or other attachment mechanisms and/or sealing mechanisms described above. In an alternative embodiment, the viewing mechanism can be one or more apertures in hood 618.

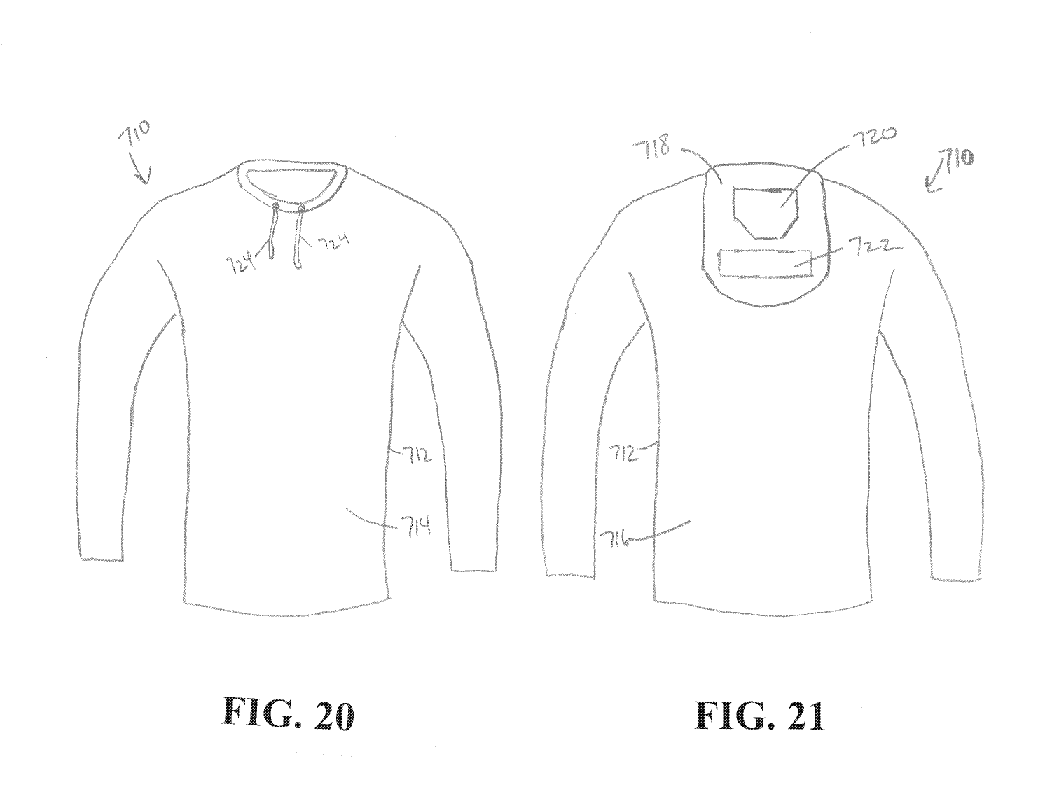

FIGS. 20 and 21 illustrate an alternative embodiment of an article of clothing 710 according to the present disclosure. In the illustrated embodiment, the article of clothing 710 is a shirt 712 with a hood 718. Like the previous embodiment, hood 718 includes a respiratory filter 720 and a viewing mechanism 722. In the non-filtering configuration shown in FIGS. 20 and 21, respiratory filter 720 is shown upside-down because its position is reversed when respiratory filter 720 is placed in the filtering configuration. Shirt 712 differs from shirt 612, however, in that shirt 712 does not have to be reversed so that rear side 716 is facing forward for the wearer to use respiratory filter 720. Rather, hood 718 is made so that the wearer can pull respiratory filter 720 over the wearer's nose and/or mouth while front side 714 is facing forward.

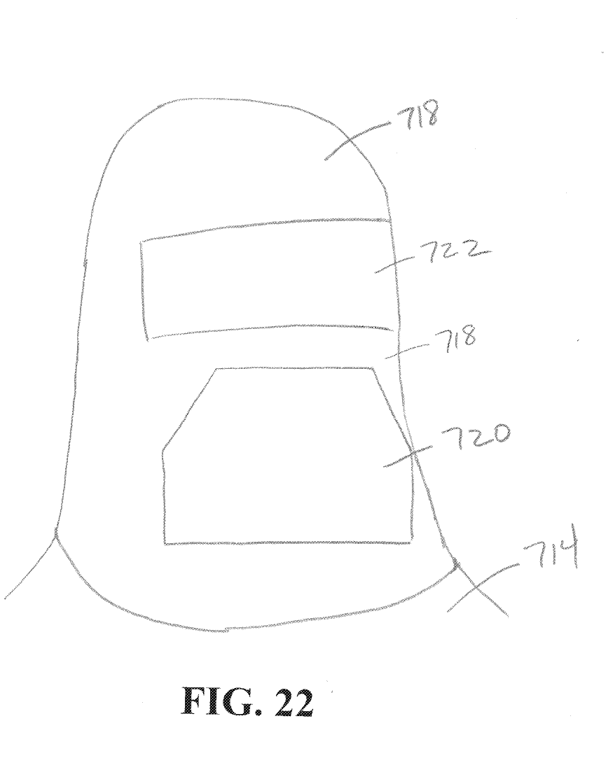

FIG. 22 shows respiratory filter 720 in the filtering configuration after hood 718 has been pulled up over the wearer's head. In the filtering configuration, respiratory filter 720 is located to cover the wearer's nose and/or mouth to filter air breathed by the wearer, and viewing mechanism 722, for example an eye guard including translucent plastic, is located to cover the wearer's eyes so that the wearer can look through viewing mechanism 722. In the filtering configuration, the wearer can tighten strings 724 to secure hood 718 around the wearer's head. In an embodiment, hood 718 can also include one or more of the nose attachment mechanism, ear attachment mechanism, chin attachment mechanism or other attachment mechanisms and/or sealing mechanisms described above. In an alternative embodiment, the viewing mechanism can be one or more apertures in hood 718.

Modifications in addition to those described above may be made to the structures and techniques described herein without departing from the spirit and scope of the disclosure. Accordingly, although specific embodiments have been described, these are examples only and are not limiting on the scope of the disclosure.

1. An article of clothing comprising:
a collar configured to be worn around a wearer's neck;
a respiratory filter positioned below the collar; and
an attachment mechanism configured to secure the collar above the wearer's nose when desired by the wearer,
wherein the respiratory filter is positioned over the wearer's nose and/or mouth when the attachment mechanism secures the collar above the wearer's nose.

2. The article of clothing of claim 1, wherein the attachment mechanism includes at least one of: (i) a nose attachment mechanism; (ii) an ear attachment mechanism; and (iii) a chin attachment mechanism.

3. The article of clothing of claim 2, wherein the nose attachment mechanism includes a bendable strip that is configured to pinch the wearer's nose when pressure is applied to the bendable strip by the wearer.

4. The article of clothing of claim 2, wherein the ear attachment mechanism includes at least one aperture in the article of clothing.

5. The article of clothing of claim 2, wherein the chin attachment mechanism includes a bendable strip that is configured to pinch the wearer's chin when pressure is applied to the bendable strip by the wearer.

6. The article of clothing of claim 1, which includes a sealing mechanism configured to seal the respiratory filter around the wearer's nose and/or mouth.

7. The article of clothing of claim 1, wherein the attachment mechanism includes at least one string that is configured to tighten the collar around the wearer's face.

8. The article of clothing of claim 1, wherein the respiratory filter includes a copper mesh material.

9. The article of clothing of claim 1, wherein the respiratory filter is shaped so that an upper edge proximal to the collar is shorter than a lower edge distal to the collar.

10. The article of clothing of claim 1, wherein the respiratory filter is shaped so that a portion covering the wearer's mouth when the collar is secured above the wearer's nose is larger than a portion covering the wearer's nose.

11. The article of clothing of claim 1, wherein the respiratory filter is shaped so that an upper edge proximal to the collar is wider than a lower tip.

12. (canceled)

13. The article of clothing of claim 1, wherein the article of clothing is a shirt.

14. The article of clothing of claim 1, wherein the collar is the top edge of an extended collar, and the respiratory filter is attached below the top edge of the extended collar when the collar is secured above the wearer's nose.

15. A wearable air filter comprising:
an article of clothing including a collar configured to be worn around a wearer's neck;
an attachment mechanism configured to secure the collar in a filtering configuration above the wearer's nose; and
a respiratory filter attached to the article of clothing below the collar and configured to be positioned over the wearer's nose and/or mouth to filter air breathed by the wearer when the attachment mechanism secures the collar in the filtering configuration.

16. The wearable air filter of claim 15, wherein the article of clothing is a shirt.

17. The wearable air filter of claim 16, wherein the respiratory filter is attached to a rear side of the shirt.

18. The wearable air filter of claim 15, wherein the article of clothing is a bib.

19-24. (canceled)

25. The article of clothing of claim 15, wherein the respiratory filter includes a copper mesh material.

26-38. (canceled)

39. A wearable air filter comprising:
an article of clothing including a collar configured to be worn around a wearer's neck;
a flap attached to the article of clothing at or near the collar, the flap configured to be flipped upwards into a filtering configuration over the wearer's nose and/or mouth;
a respiratory filter attached to the flap so as to be positioned over the wearer's nose and/or mouth to filter air breathed by the wearer when the flap is flipped upwards into the filtering configuration over the wearer's nose and/or mouth; and
an attachment mechanism configured to secure the flap in the filtering configuration over the wearer's nose and/or mouth.

40. The wearable air filter of claim 40, wherein the flap is a hood.

41-42. (canceled)
